(19) United States
(12) Patent Application Publication
(10) Pub. No.: US 2002/0021311 A1
(43) Pub. Date: Feb. 21, 2002

(54) Data entry using a reduced keyboard

(75) Inventors: Erez Shechter, Tel Aviv (IL); Nir Bar-Lev, Tel Aviv (IL); Yitzhak Birk, Hod-Hasharon (IL)

Correspondence Address: G.E EHRLICH (1995) LTD., c/o ANTHONY CASTORINA, SUITE 207, 2001 JEFFERSON DAVIS HIGHWAY, ARLINGTON, VA, 22202, US

(73) Assignee: ApproxiMatch Ltd.

(21) Appl. No.: 09/827,909

(22) Filed: Apr. 9, 2001

Related U.S. Application Data
(60) Provisional application No. 60/226,693, filed on Aug. 22, 2000.
(60) Provisional application No. 60/227,846, filed on Aug. 25, 2000.
(60) Provisional application No. 60/225,177, filed on Aug. 14, 2000.

(51) Int. Cl. G06F 3/023

(52) U.S. Cl. 345/864

(57) ABSTRACT

An ambiguity resolver having an input for receiving a data string entered using an ambiguous keyboard, a comparator for comparing the data string to be searched against a plurality of prestored words to find at least one closest match to the data string, and an output for outputting a comparison result. An ambiguous keyboard is one in which more than one character is mapped to a single key, a particular example being a telephone keypad used for entering all the alphanumeric characters.

### RELATIONSHIP TO EXISTING APPLICATIONS

The present application is a continuation of U.S. Provisional Application No. 60/226,693 filed Aug. 22, 2000, U.S. Provisional Application No. 60/227,846 filed Aug. 25, 2000 and U.S. Provisional Application No. 60/XXXXXX filed Aug. 1, 2000, attorney docket no. XXXXX.

### BACKGROUND OF THE INVENTION

Recent developments such as WAP (wireless access protocol) have opened up the use of the mobile or cellular telephone as a means of accessing the Internet. Proposed third generation cellular telephone protocols are expected to render the mobile telephone an even more vital tool of data and computer network communication.

Existing data networks such as the Internet were, however, designed to be accessed using a full alphanumeric keyboard, and essential features of computer network communication, such as addressing, are based on the assumption that the user has a full typewriter keyboard. Small devices, such as telephones, generally only have a numeric keypad. Generally such keyboards are able to serve as “reduced keyboards” for alphabetic characters and individual keys represent several characters, which are selected between by the number of presses on the key. Hence multiple presses on individual numerical keys give rise to the different alphanumeric characters, but the arrangement is cumbersome and difficult for inexperienced users. Multiple pressing increases the time spent on entry of each individual data item and presents additional opportunity for error.

Such reduced keyboards are found principally on telephones of all kinds including cellular telephones, which may be WAP enabled, and are also the basis of devices for handicapped people who are unable to manipulate normal-sized keyboards. As well as the conventional reduced keyboards, other small and portable devices such as personal digital assistants, may have reduced keypads of different kinds. In particular, PDAs may use a touch pen or a touch screen to write data or to click on keys on a graphically depicted region of the screen.

In addition to addressing, be it entering a URL or an e-mail address or any other addressing function, an important way of navigating the Internet is through the use of search engines. Use of a search engine generally requires entry of alphabetic data. Furthermore, use of a search engine requires data to be entered accurately. Current search engines do not deal with misspellings or variant spellings. If the string entered is not present in the document they do not find it.

Whichever of the above data entry methods is used, the mobile device is often being operated whilst the user is on the move, and not in the most ideal surroundings, standing on a crowded commuter train, waiting in a traffic jam etc. The user is therefore not kindly predisposed towards having to rekey a letter if a word is misspelt or having to repeat data entry because of a bad interface.

One of the most common uses of the Internet is for e-mail. E-mail services are provided in two ways. One way is through an Internet service provider to whom a user logs on with a mail program to download messages to his computer. The service is generally provided by applications which are located on dedicated e-mail servers. To access these servers the user is generally required to make a direct connection to the server using a protocol such as the PPP access protocol.

Another way of providing e-mail is to provide it over the Internet through world-wide web servers. Access is obtained by users through their web browsers from any web-enabled device.

Another popular use for the Internet is Instant Messaging (IM). IM services such as ICQ™ provide a service that allows users to send short messages to each other in real time or near real time. It also provides for searching amongst a user database using a wide range of criteria for persons to communicate with and may show the online status of a user with whom one is intending to communicate. IM services are generally provided from web servers in conjunction with client programs located with the individual user.

IM and e-mail are two means of communications that differ in their scale and in the time context in which they work. IM is intended for online contact in what is essentially a chat session, or simply for sending short messages.

E-mail is less size-limited and may be used for long messages and for sending data of all kinds in the form of file attachments. E-mail does not necessarily provide the instant effect of IM, it generally taking between several seconds and several hours before an e-mail is delivered.

E-mail is sent using an e-mail address having comprising a user name and several levels of domain name, such as username@domain.general.country. The domain name specifies the IP address of the e-mail server and the username specifies a given account at the e-mail server. The user does not require an IP address. The Internet knows about the server only.

IM addresses are generally numerical codes. Each user receives a unique number and is thus uniquely identified on the system. Users may then enter names, pseudonyms and other data to be associated with the numerical code.

When sending an e-mail, the user does not immediately know if the email is correctly addressed. An error in the domain name leads to the e-mail being passed around the web until a time-out is reached or a “no corresponding mailbox” message is sent to the user from an Internet management program, and this may take anything from several hours to several days.

If the error is in the username then the Internet sends the message to the mail server as normal because the Internet has no record of what users are present on the mail server. The mail server, being unable to assign the e-mail to a user may issue an error message to the sender but increasingly in company e-mail servers, the trend is to send all messages not having a correct user name to a default mailbox.

The sender of the incorrectly addressed e-mail may thus at best have to wait some time before he is informed that the e-mail was never delivered, and at worst he may never learn of the error.

If incorrectly addressing an IM message, the IM service generally returns a “not found” message. The user is then faced with having to use the IM provider's search engine to try and find the correct address of the user, and this may involve trying different spellings of the name, and perhaps different combinations of first and family names. This is awkward, especially if attempted using a reduced keyboard.

Call centers provide directory enquiry services generally to telephony operated devices. These services allow a caller to obtain the telephone number of another customer or to be connected directly thereto. Such services are often handled by human operators, but may be automated for use via telephone tone-driven menus or the like. The devices used to connect to such services include telephony-enabled devices such as telephones, mobile telephones, and hand-held mobile devices such as PDAs. Generally these devices have reduced keyboards of the type mentioned above, making it awkward to enter strings to search, even more awkward to enter alternatives and likewise awkward to alter a misspelling. On the other hand, the biggest cost of running a call center is the cost of the staff and therefore it is highly desirable to automate the call center service as much as possible.

Database systems of large numbers of text-based documents, some of which may include large volumes of text, generally provide a facility for searching through the documents using keywords. Typically simple searches for keywords can be augmented by more sophisticated searches in which keywords are linked together using Boolean logical operators. Searches are generally possible for phrases as well as words and generally such a facility is only available for searching text.

Generally, the searches are exact. If a keyword such as “e-mail” is entered, the search will not retrieve a document containing the word “email”. A search using the keywords “database text” applied to the preceding paragraph would not return a result because, although both words appear in the paragraph, they do not appear together. However the closely related search “database AND text” in which the two words are related by the Boolean operator AND, will declare a positive result when applied to the above paragraph because the AND operator causes it to search for the two words separately.

Thus, the use of standard searches is limited by the exact matching required. Phrase matching, in which a series of keywords are given in order, may fail because the phrase may be slightly reworded, or the user does not know the exact phrase, or a word therein may be misspelled or the phrase has several common forms.

A prior art solution for reading data from an ambiguous keyboard is U.S. Pat. No. 6,011,554, Reduced Keyboard Disambiguating System, in which a series of objects are stored in a vocabulary database and which are associated with given keystroke combinations so as to be selected without having to spell out the full word accurately.

U.S. Pat. Nos. 5,953,541 and 5,818,437 describe a method of comparing data entered via an ambiguous keyboard with a vocabulary set, and presenting the user with all words in the vocabulary set that correspond with the series of keystrokes used to enter the data.

### SUMMARY OF THE INVENTION

All of the above problems may be eased by an effective system of approximate searching, which system is able to make a useful estimate of the word that the user is entering via the reduced keyboard before he has completed the data entry, and which is able to complete searches beyond the scope of literal answers to the search.

Searching is currently only efficient for data. Effective approximate matching may be expected to be useful for searching of other forms of data in which structural relationships are definable.

According to a first aspect of the present invention there is thus provided an ambiguity resolver having

an input for receiving a data string entered using an ambiguous data source,

a comparator for comparing the data string to be searched against a plurality of strings to find at least one closest match to the data string,

and an output for outputting a comparison result.

Preferably, the comparator comprises a distance assessor for assessing a distance of any of the plurality of prestored words to the data string based on a mapping of characters of the word and of the data string to keys of the ambiguous keyboard.

Preferably, the distance assessor is operable to assign a minimal distance between pairs of characters sharing a single key of the ambiguous keyboard.

Preferably, the ambiguous data source is any one of a group comprising a graphical data input, an ambiguous keyboard and a speech converter.

Preferably, the distance assessor comprises a pattern matcher operable to assess the distance based on pattern matching.

Preferably, the output is data associated with the at least one closest match.

Preferably, the output is the at least one closest match.

Preferably, the plurality of words are stored in at least one database.

Preferably, at least some of the prestored words are user-specific words.

Preferably, the input data string is a plurality of words and the output is a phrase.

Preferably, the speech convertor is a speech processor capable of converting speech into either one of a string of phonemes and text string.

Preferably, the output is connectable to the input of a further approximate search engine.

Preferably, the database comprises electronic network address information of a plurality of network users.

Preferably, the electronic network address information is any one of a group comprising

Intranet email addresses, Internet email addresses, IM addressing data, and URL data.

According to a second aspect of the present invention there is provided the use of an approximate search engine on data strings entered using an ambiguous keyboard, to resolve key ambiguities of the ambiguous keyboard.

Preferably, the approximate search engine comprises a distance assessor operable to assess a distance of any of a plurality of prestored words to the data string based on a mapping of characters of the word and of the data string to keys of the ambiguous keyboard.

Preferably, the distance assessor comprises a pattern matcher for assessing the distance using pattern matching between the input data string and any one of the prestored words.

Preferably, the plurality of words are stored in at least one database.

Preferably, at least some of the prestored words are user-specific words.

Preferably, the input data string is a plurality of words and wherein the approximate search engine is further operable to match phrases to the plurality of words which have been resolved.

Preferably, the database comprises electronic network address information of a plurality of network users.

Preferably, the electronic network address information is any one of a group comprising

Intranet email addresses, Internet email addresses, IM addressing data, telephone numbers, telephone numbers combined with other address information, and URL data.

According to a third aspect of the present invention there is provided an approximate search engine having

an input for receiving a data string from a mobile telecommunication device,

an approximate string comparator for comparing the input data string against a plurality of prestored words to find at least one prestored word being closest to the input data string, and

an output for outputting the at least one closest prestored word.

Preferably, the comparator is operable to assess a distance of any of the plurality of prestored words to the data string based on a mapping of characters of the word and of the data string to keys of the ambiguous keyboard.

Preferably, the comparator is operable to assess the distance based on pattern matching.

Preferably, the output is usable to obtain data associated with the closest prestored word.

Preferably, the plurality of words are stored in at least one database.

Preferably, at least some of the prestored words are user-specific words.

Preferably, the input data string comprises a plurality of words and the plurality of prestored words are associated with phrases.

Preferably, the input data string comprises a plurality of words and the plurality of prestored words are phrases.

Preferably, the input is connected to the output of a speech processor operable to convert speech input into text.

Preferably, the database comprises electronic network address information of a plurality of network users.

Preferably, the electronic network address information is any one of a group comprising

Intranet email addresses, Internet email addresses, telephone numbers, telephone numbers associated with other identifying data, IM addressing data, and URL data.

Preferably, the plurality of prestored words is a user directory containing identification and address information of network users and which approximate search engine comprises a voice interface for interfacing with the mobile telephony device.

The approximate search engine is preferably operable to receive query data from the mobile telephony device, disconnect from the mobile telephony device, process the query and reconnect to the mobile telephony device to send a result.

According to a fourth aspect of the present invention there is provided an approximate search engine having

an input for receiving a data string to be searched,

a comparator for comparing the data string to be searched against a plurality of prestored words to find at least one closest match to the data string,

and an output for outputting a comparison result,

wherein the comparator comprises a pattern matcher for obtaining the at least one closest match by pattern matching.

Preferably, the output is data associated with the at least one closest match.

Preferably, the output is the at least one closest match.

Preferably, the plurality of prestored words are stored in at least one database.

Preferably, at least some of the prestored words are user-specific words.

Preferably, the input data string comprises a plurality of words and the plurality of prestored words are associated with phrases.

Preferably, the input data string comprises a plurality of words and the plurality of prestored words are phrases.

Preferably, the input is connected to the output of a speech processor operable to convert speech input into text.

Preferably, the database comprises electronic network address information of a plurality of network users.

Preferably, the electronic network address information is any one of a group comprising

Intranet email addresses, Internet email addresses, telephone numbers, telephone numbers associated with other identification information, IM addressing data, and URL data.

The approximate search engine may further comprise a voice interface, for interfacing with a telephony device or other voice based system.

The approximate search engine is preferably operable to receive query data from the telephony device, disconnect from the telephony device, process the query and reconnect to the telephony device to deliver a result.

According to a fifth embodiment of the present invention there is provided a mobile data processing device having

an ambiguous keyboard for entering a number of input characters via a smaller number of input keys, wherein at least one key has a plurality of the input characters mapped thereto,

an approximate searching, engine, and

a database of expected strings,

wherein distances are predefined between input characters based on respective keys to which they are mapped, and wherein the approximate searching engine is operable to match a given input string against the expected strings to produce at least one candidate string having a minimal distance to the input string.

According to a sixth aspect of the present invention there is provided a method of entering precise data into a system via an ambiguous keyboard, comprising the steps of:

entering the data ambiguously via the ambiguous keyboard,

comparing the data against a database of likely inputs using an approximate search engine until at least one closest match is determined, and

selecting the at least one closest match as precise input.

Preferably, the approximate searching method is either or both of neural network algorithms and pattern matching.

In an embodiment the data is a word.

In another embodiment, the data is a phrase.

In a further embodiment, the phrase is part of the lyrics of a song.

Preferably, the data input is carried out at a mobile data processing device and approximate searching is carried out remotely.

Preferably, the data input and approximate searching are carried out at a mobile data processing device.

Preferably, the database is any of a dictionary of a predetermined language, a database of address information, a phrase dictionary, an index of documents, an index of websites, an index of song lyrics, an index of identification information and a graphical index of identification information.

According to a seventh aspect of the present invention there is provided an interactive television system comprising an ambiguity resolver, having

an input for receiving a data string entered using an ambiguous data source,

a comparator for comparing the data string to be searched against a plurality of strings to find at least one closest match to the data string,

and an output for outputting a comparison result.

Preferably, the comparator comprises a distance assessor for assessing a distance of any of the plurality of prestored words to the data string based on a mapping of characters of the word and of the data string to keys of the ambiguous keyboard.

Preferably, the distance assessor is operable to assign a minimal distance between pairs of characters sharing a single key of the ambiguous keyboard.

Preferably, the ambiguous data source is any one of a group comprising a graphical data input, an ambiguous keyboard and a speech converter.

Preferably, the distance assessor comprises a pattern matcher operable to assess the distance based on pattern matching.

Preferably, the output is data associated with the at least one closest match.

Preferably, the output is the at least one closest match.

Preferably, the plurality of words are stored in at least one database.

Preferably, at least some of the prestored words are user-specific words.

Preferably, the input data string is a plurality of words and the output is a phrase.

According to an eighth aspect of the present invention there is provided a reduced keyboard having a first number of input keys representing a second number of input characters wherein the second number is greater than the first number such that a plurality of characters are mapped to at least some input keys, wherein the characters are divided into groups and wherein the reduced keyboard has a mode switch for switching the input keys between each group of characters.

Preferably, one group comprises the numeric characters and another group comprises the alphabetic characters.

According to a ninth aspect of the present invention there is provided an automated call center comprising an approximate search engine and a database and wherein incoming strings serve to interrogate the database using the approximate search engine to output subscriber contact data.

Preferably, the automated call center comprises a speech to text engine for converting user speech into an incoming string. Thus the call center is able to receive speech instruction.

Additionally or alternatively, the approximate search engine is operative to compensate for data entered via an ambiguous keyboard. Thus the automated call center is operable to receive data strings directly. In this embodiment, the user may send the query as an annex to the telephone number of the call center and thus the query may be processed offline.

According to a tenth aspect of the present invention there is provided an electronic network address verifier comprising a database of addresses on the electronic network, a message address checker and an approximate search engine, and wherein the checker is operable to identify an address in a message for the network and to use the address to interrogate the database using the approximate search engine.

The verifier is preferably operable to identify closest matches to the address, and wherein, when the closest match is not an exact match, to identify the closest match as a correction.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a generalized diagram showing a typical reduced or ambiguous keyboard as may be found on many telephony devices,

FIG. 2 is a generalized block diagram illustrating an ambiguity resolver operative in accordance with a first embodiment of the present invention,

FIG. 3 is a generalized block diagram illustrating an ambiguity resolver according to the embodiment of FIG. 2 resolving an ambiguous input string entered by a user of a mobile telephony device,

FIG. 4 is a generalized block diagram showing a further stage in the use of an ambiguity resolver in resolving an ambiguous input string entered by a user,

FIG. 5 shows a user screen of a mobile telephony device as it may appear following the stage of FIG. 4,

FIG. 6 shows a phrase resolver according to one embodiment of the present invention, resolving a phrase partly input by a user,

FIG. 7 shows a phrase resolver according to the embodiment of FIG. 6 at a previous stage of resolving ambiguity in a user input,

FIG. 8 is a simplified block diagram showing a further embodiment of the present invention for resolving ambiguously entered user addresses on a network, and

FIG. 9 is a simplified diagram illustrating a further embodiment of the present invention for resolving address data entered by a user to obtain a corresponding telephone number or like information so as to provide an automatic call center service.

### DESCRIPTION OF THE PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

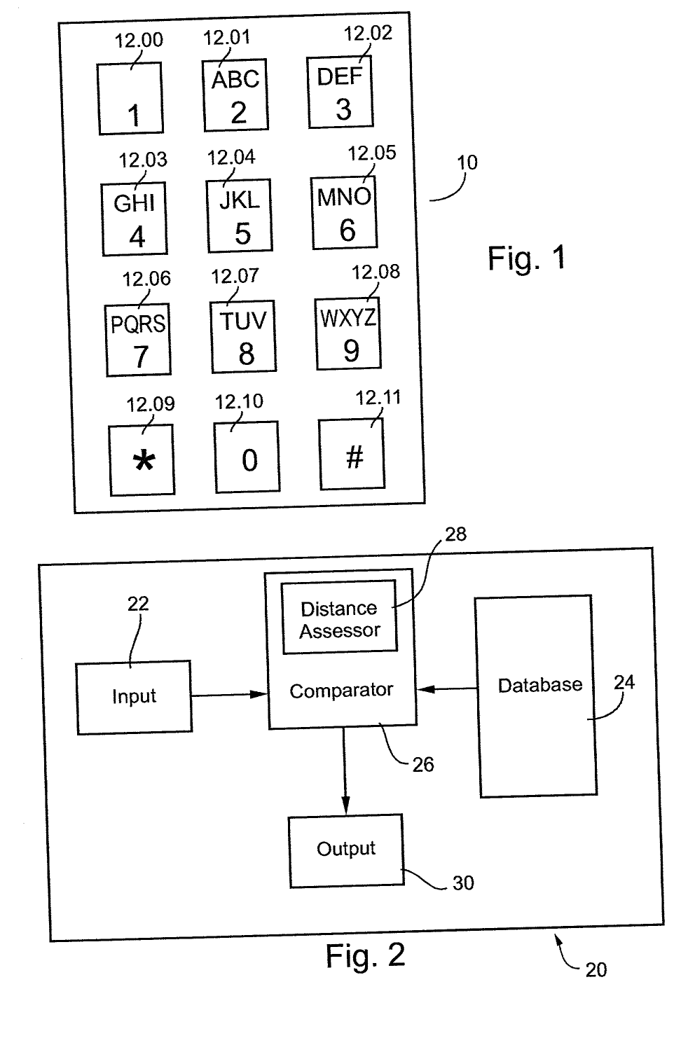

Reference is now made to FIG. 1, which is a diagram of a typical telephone keypad 10, comprising twelve keys 12.00 . . . 12.11 as may be found generally on most modern telephony devices, whether fixed or mobile. As long as the keypad is used only for dialing telephone numbers, or entering numerical information the keypad is entirely adequate. However, with data services such as Internet being provided via telephone devices, it additionally becomes necessary to enter alphabetic characters via the keypad. As there are only 12 keys and 36 alphanumeric characters it is necessary to assign or map several characters to a single key. For example key 12.01 is assigned the numeral “2” and the alphabetic characters “a”, “b”, and “c” in that order. One depression of the key 12.01 produces the output “2”. Two depressions produce the output “a”, three depressions produce “b” and four depressions produce “c”. Each key taken by itself is ambiguous as to individual input characters specified thereby and thus the keypad 10 is also known as an ambiguous keypad.

The use of such a keypad to enter alphanumeric data is very laborious and easily prone to error. A typical data string of four alphabetic characters typically requires a minimum of four and a maximum of sixteen key presses. An ability to enter substantially all of the alphanumeric characters is necessary for even the most elementary use of the Internet. Such elementary use generally includes entering URLs or e-mail addresses, log-on names, passwords, writing messages and entering strings to be searched. Communication devices, and particularly portable communication devices, are generally made as small as possible, and it is not practical to include a full typewriter type keyboard. Since the device may be used whilst on the move when the user cannot be expected to have two hands free, it is also not practical to provide solutions involving combinations of keys, such as with the shift key of the conventional keyboard.

Reference is now made to FIG. 2, which is a first embodiment of an ambiguity resolver 20 according to a first embodiment of the present invention. In the ambiguity resolver of FIG. 2, an input device 22 may be a reduced or ambiguous keypad 10 such as that shown in FIG. 1 or it may be a buffer or the like for receiving data from such a reduced keyboard which may be remotely located. A database of likely inputs 24 is located in association with the input 20 such that likely inputs stored in the database may be compared therewith, preferably using a comparator 26.

The database of likely inputs may be a dictionary of all known words in a given language plus names, addresses and other information that may serve as inputs. The database, however, is not restricted to textual data but may contain likely input of any kind, as will be discussed in greater detail below.

In an embodiment, the ambiguity resolver 20 comprises an approximate search engine (hereinafter ASE) which may use any one of a series of approximate matching techniques, including Natural Language Processing, Neural Networks, Pattern Matching, to find similar strings to a query string. In this connection, reference is made to applicant's U.S. patent application Ser. No. 09/438,882, the contents of which are hereby incorporated by reference, and which considers approximate searching methods in detail. A distance assessor 28 assesses the distance (a measure of the difference) between the query string and comparison strings in the database. In general, a string having a minimal distance to the query string is selected as a suggested output and sent to an output unit 30. The output unit may be a screen associated with reduced keypad 10.

If there is no single candidate string having a clear shortest distance but rather two or more strings have an approximately equal lowest distance then in one embodiment the two or more strings may all be offered to the user as suggested outputs and he may be asked to select between them.

Numerous algorithms for performing approximate matching are available to the skilled person and the present invention is not limited to any particular algorithm. Any algorithms providing approximate string matching or pattern matching are generally regarded as suitable. However, for the sake of completeness, two possible algorithms are described below.

One preferred method of performing approximate string matching is to carry out an exhaustive search throughout an entire dictionary and, for each entry in the dictionary to calculate a distance to the string being tested.

A further preferred method for approximate searching is firstly to find any exact matches between the candidate string and strings in the database. A decision tree type structure is preferably used for this stage of the search so as to avoid the necessity of searching every string in the database 24. If no exact matches are to be found then an assumption is made that only a single error is present in the string. The query string is preferably divided into two, one half of which is assumed to be error-free since there is presumed to be only a single error in the entire string. Each half is therefore compared to strings in the database, in the same way as before, to produce further candidates, and the further candidates are then compared with the full string to find the closest match.

The embodiment may be used to determine a precise input that corresponds to an approximate input entered by the user. This includes both identifying correct spelling and resolving keyboard ambiguity, which are both essentially the same task as far as ambiguity resolution is concerned. In addition, as will be described in more detail below, the embodiment may use approximate searching algorithms to locate documents and like material.

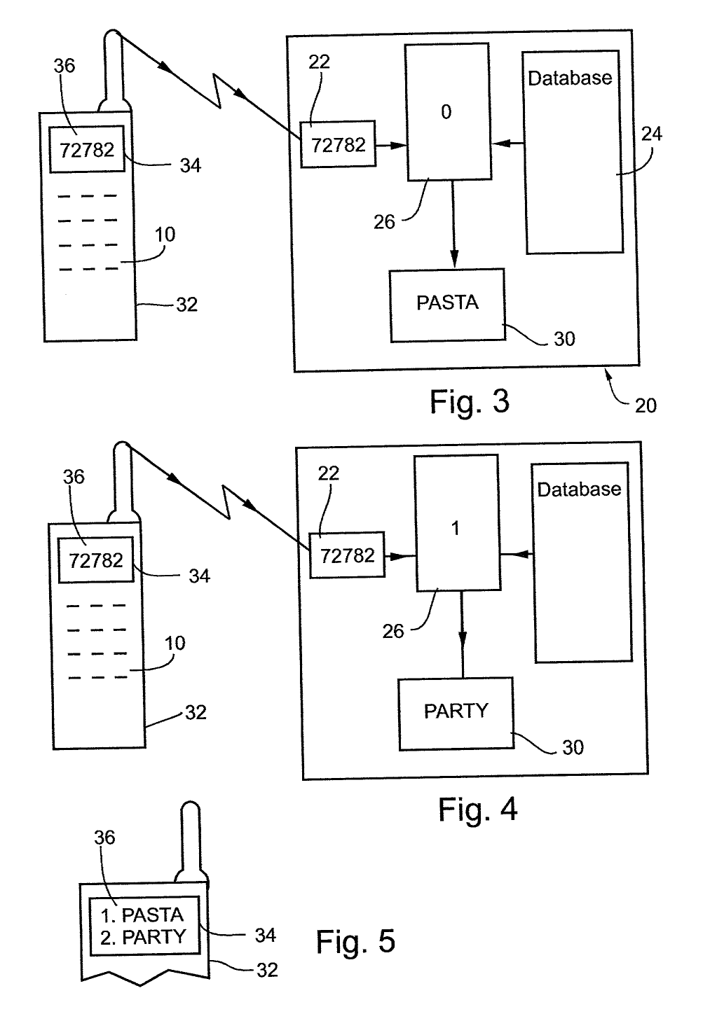

Reference is now made to FIG. 3, which is a simplified diagram of a mobile telecommunication device having a reduced keyboard of the kind shown in FIG. 1 being connected to an ambiguity resolver of the kind shown in FIG. 2, and exemplifying how use of a distance assessor may allow input key ambiguity to be resolved. Parts that are identical to those shown above are given the same reference numerals and are not referred to again except as necessary for an understanding of the present embodiment. A mobile telecommunication device 32 comprises a reduced keyboard 10 and a screen 34. A user input string 36 is displayed on the screen, which indicates that the user has pressed keys 7, 2, 7, 8, and 2 in that order. The context indicates that a textual input is intended. Preferably, the distance assessor 28 is arranged to recognize a small distance between different characters on the same key, so that for example the distance between any of the characters 2, A, B, and C is small. In a preferred embodiment, the difference between characters that share an input key is zero. For simplicity, such an embodiment will be used in the description of the following examples. However, distances may be set between the characters based on the number of repeat presses assigned to each on the respective key so that a distance of 1 may be set between a “2” and an “A”, since one is obtained by a single press of the “2” key and the other by two presses thereof. A distance of 1 may again be set between an “A” and a “B”, but a distance of 2 would be set between a “1” and a “B”. In this example, a distance of 3 is preferably set between characters on adjacent keys and a distance of 4 between characters on non-adjacent keys.

In another preferred embodiment a distance of 1 may be set between any characters sharing a key, a distance of 2 between characters on adjacent keys and a distance of 3 between any other characters.

Smaller distances may be set between commonly confused characters such as “G” and “J” or “S” and “Z”, as desired.

The input string 36 is transmitted to an ambiguity resolver 20 where it is compared to a textual database 24, the comparator 26 being set to find strings having a distance of zero. In the example, a single string “pasta” is found as the only output giving a distance of zero. Thus, the user is preferably enabled to press each ambiguous key only once and in many cases the ambiguity resolver is able to identify the intended output.

In an alternative embodiment, the user is able to switch the ambiguous keyboard between a first mode in which each key gives a numerical output and a second mode in which each key gives an alphabetic output.

Reference is now made to FIG. 4, which is a simplified diagram showing the query of FIG. 3, but with a distance of 1 being set in the comparator 26. Parts that are identical to those shown above are given the same reference numerals and are not referred to again except as necessary for an understanding of the present embodiment. In this case the input string “72782” gives the same output “pasta” as before, but an additional output of “party” is also identified, since this would be correctly input as a string “72789” and therefore represents a single error by the user.

Reference is now made to FIG. 5 which shows how the two outputs could be presented to a user, via screen 34, in such a manner that he is able to select between them by pressing a single key.

The example explained above in respect of FIGS. 3-5 is simplified in that a distance of “0” was defined between characters sharing an input key and a distance of “1” for characters not sharing a key. However, as already discussed, in preferred embodiments, it is possible to define distances in different ways according to circumstances. For example a fractional distance may be defined between characters sharing a key. A distance of “1” may be defined between characters on adjacent keys and a distance of “2” between all other keys. Likewise, account may be taken of common misspellings, for example by defining a short distance between an “s” and a “z”.

In a particularly preferred embodiment, the device through which the user is connected identifies the user, typically by means of a login procedure. The ASE is thus able to maintain a database individualized for each given user. Such a database may be used to store any words which have been used by the individual user and which are not found in the general database, so that the words will not be queried the second time they are used, or the words may be recognized in future when entered inaccurately. Alternatively or additionally, whenever a user selects between two or more outputs having the same distance therebetween, such a personal database may be used to record the choice made so that on subsequent occasions the system may make an informed guess as to which word is required.

The embodiments described with respect to FIGS. 2-5 may be associated with a speech to text converter (not shown) so that a user may speak the desired phrase or keywords into the converter, instead of using a reduced keypad. The converter preferably converts the speech into text. Should the conversion to text be erroneous, the ASE may compensate for the error and a search for the desired phrase may be carried out as described above.

As a variation of the above, a speech processor may simply convert a spoken input from the user into phonemes. Likewise, the database 20 may be stored in the form of phoneme strings. Thus the ASE may carry out its search on the strings of phonemes to produce a verbal output.

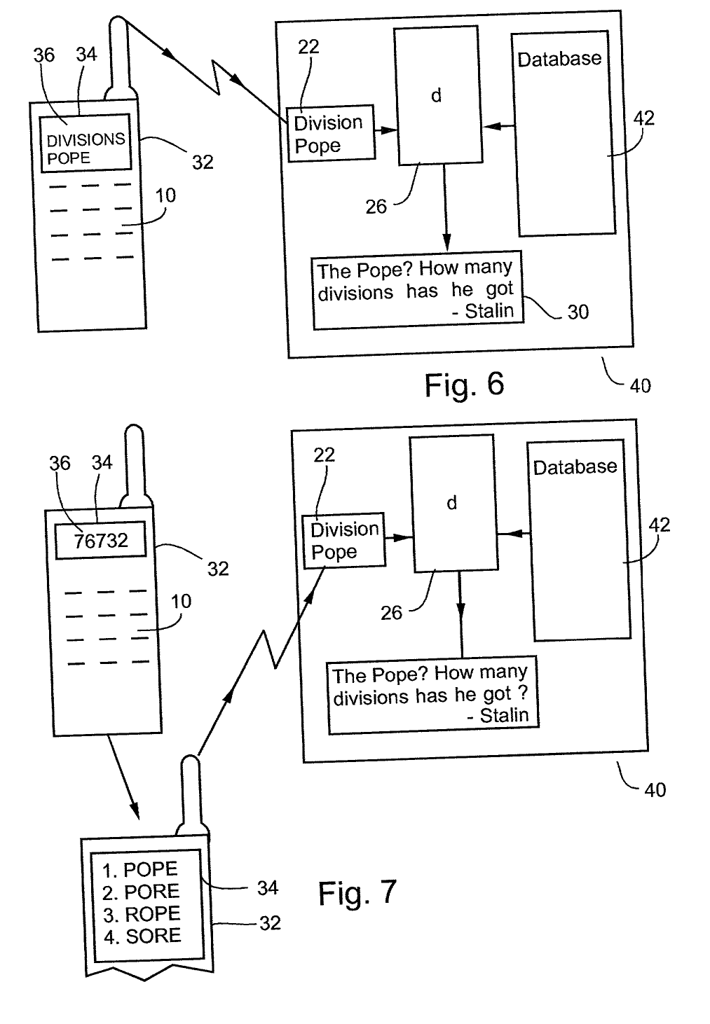

Reference is now made to FIG. 6, which is a simplified diagram illustrating a preferred embodiment of the present invention useful for searching for phrases or like word combinations. The embodiment is useful for finding an incorrectly remembered phrase or for searching for a document having a given phrase or for searching for a document having an imprecisely remembered phrase. Parts that are identical to those shown above are given the same reference numerals and are not referred to again except as necessary for an understanding of the present embodiment. In the example, a user has a phrase in mind which he does not remember exactly. He remembers the wording “How many divisions has the Pope?” Thus, in one embodiment, he enters, using his reduced keyboard, the two words “division” and “Pope”. A second embodiment, involving pattern matching between full strings, will be discussed in more detail below.

The two words “division” and “pope” may themselves be recognized from the input at a reduced keyboard 10 using the ambiguity resolver 20 described above, and FIG. 7 illustrates some possibilities that an ambiguity resolver may present if an input string of “7673” were presented to it. However, it will be appreciated that the present embodiment extends also to data entered using a full keyboard or in any other way.

The two words “division” and “pope” are preferably sent to a phrase resolver 40, which is structurally similar to the ambiguity resolver 20 referred to previously, in particular in that it uses an ASE. However, it comprises a database 42 of phrases or of an index of documents such that an approximate search may find a phrase corresponding to an input query comprising keywords, or may find a document containing the keywords. In an embodiment of the document search, it may be a condition of the search that the keywords are found in proximity to one another, the definition of proximity being set by the system designer or by the user as preferred. A typical definition of proximity would lie between ten and fifteen words.

The phrase resolver carries out an approximate search on the keywords “division” and “pope”. In the present example it would find no exact matches because the word “division” as such does not appear and it is necessary to use an approximate search algorithm. The approximate search algorithm used as an example above would determine there are no exact matches and then it would split the search query, preferably by searching for each of the keywords separately, based on the principle that one of the keywords is correct. A search for the word “pope” in all of the phrases having “division” reveals no close results. However, a search for “division” in all of the phrases found to have the word “pope” reveals one phrase having the word “divisions” which is at distance “1” from the word “divisions”. The corresponding phrase is sent to the output 30, to reveal the full quotation:

“The Pope? How many divisions has he got?—Stalin.

In the document searching embodiment, the result to be sent to the user would be one or more documents containing the corresponding phrase.

In the embodiment of FIG. 6, a distance d of “0” is first defined in the comparator 26 for the exact search. If no exact match is found then, as described, the keyword space is divided in two and exact matches are made for each keyword. Then the phrases for each keyword are themselves searched for the other keyword using a distance d of “1”.

In the present embodiment, phrase searching may use a group of words which are searched for as part of a localized group in one or more entries in the database or in one or more documents indexed in the database. The phrase query may draw matches that are not exact, as in the above example in which some of the words do not match exactly, or when the query words are in an incorrect order or even when some of the words are missing. Appropriate pattern matching algorithms may be expected to identify a target phrase even if some of the keywords given are not found in the candidate string.

In addition to searching for keywords as a localized group, as described above, a further embodiment allows the user to enter his version of an entire phrase as a search string. The phrase, comprising several words, is treated as a single search string, and pattern matching techniques are used to match the input search string to phrases to be found in the database. Appropriate pattern matching techniques measure similarities and differences rather than looking for exact matches, and thus may find similar phrases, or different versions of the phrase forming the search string query.

Again, such pattern matching techniques may find matches even when words in the query have been misspelled or which appear in the wrong order or where the query has words missing or which has additional words not to be found in the candidate phrase.

It will be appreciated that the above mentioned search algorithms are only one of numerous search algorithms that may be used in this and the other embodiments.

The two embodiments described with respect to FIG. 6 may allow users to search for songs by means of phrases remembered from the lyrics.

The embodiments described with respect to FIG. 6 may be associated with a speech to text converter (not shown) so that a user may speak the desired phrase or keywords into the converter. The converter preferably converts the speech into text. Should the conversion to text be erroneous, the ASE may compensate for the error and a search for the desired phrase may be carried out as described above.

As a variation of the above, a speech processor may simply convert a spoken input from the user into phonemes. Likewise, the database 42 may be stored in the form of phoneme strings. Thus the ASE may carry out its search on the strings of phonemes to produce a verbal output.

A server on which the approximate matching facility is located, or a server which is the target for searching via user end approximate matching, may be enabled for IVR, (interactive dialog), SMS, WAP, or 3G, and communication with the server preferably uses the appropriate format.

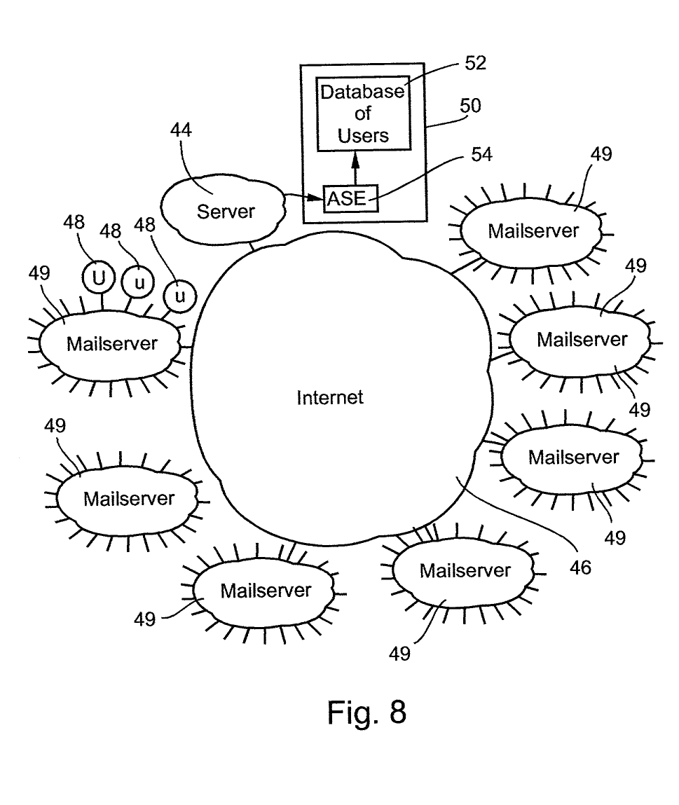

Reference is now made to FIG. 8, which is a simplified diagram showing a further embodiment of the present invention. A server 44 is connected to a network such as the Internet 46, and a series of users 48 are attached either to the same server 44 or to other mail servers 49 connected to the network 46. Each user has a mail address which comprises a username and an identification of the server to which he is attached, in the form user@server.location. The network 46 may have a record of the server names and server locations but the mail servers are conventionally the only locations which have a list of their respective user names.

As discussed above, if an e-mail address is mistyped and an e-mail thereby sent to a non-existing address, there may be considerable delay before the error is brought to the attention of the sender. In the present embodiment an address resolver 50, similar in structure to the ambiguity resolver 20 and the phrase resolver 40, has a database 52 comprising user names associated with the network 46, which may be an intranet or one or more given domain names on the Internet or of larger groupings. The address resolver 52 uses an approximate search engine 54, as described in the previous embodiments, to match an input string to user names stored thereon. If an unambiguous match is found then the e-mail is sent in the normal manner. If no unambiguous match is found then the above-discussed search algorithm may be used to divide the address into two parts, typically a user part and a domain name part, and assume that one is correct and one is erroneous, thereby to find one or more closest matches. The user is then offered the one or more closest matches as suggested corrections of the e-mail address he has entered, and he is able to select the desired address and send the e-mail in the normal way.

In one embodiment, the approximate search engine is located on a mailserver 49 and comprises a list of users of the given mailserver. This has the advantage that it is easy to update user names but it has two disadvantages, a first of which is that it does not provide an effective solution if the domain name has an error, and secondly, since the e-mail has to reach the target mail server before the address is checked, it does not necessarily provide an appreciable time saving over the standard Internet notification system.

Thus in a preferred embodiment, the database of users is held independently of individual mail servers, which mail servers automatically update it with additions or deletions of user names. All e-mails that are sent are first checked against the database and only then forwarded to their destinations.

In a further embodiment, the addresses held in the database of users 52 are not e-mail addresses but are instant messaging service (IM) numbers and IM messages are checked thereby.

In the embodiment of FIG. 8, the user thus preferably receives either immediate conformation that he has sent an e-mail or instant message to a legal address or he is offered possible address corrections if suggestions are available.

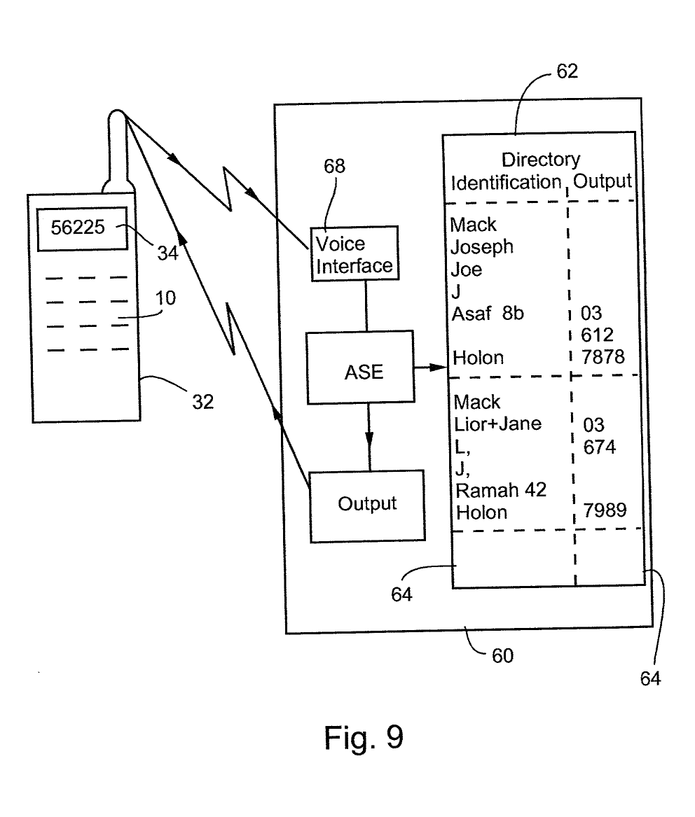

Reference is now made to FIG. 9, which is a simplified diagram showing an embodiment of the present invention in use as part of an automated call center system. A telephone number identifier 60 is similar in structure to the ambiguity resolver 20 the phrase resolver 40, and the address resolver 50, except that the database used is a telephone directory 62 having an identification field 64 and an output field 66. The identification field 64 has user identification information such as a first name, first name of spouse, nickname, initial, street address and town. In the output field 66 is a corresponding telephone number.

A user dials the call center and enters identification data of a telephone number he is seeking via a reduced keypad 10. In one embodiment the user enters the identification data immediately following the telephone number prior to dialing, so that the identification data is sent immediately upon making contact. The user then disconnects whilst a search is carried out and is reconnected to receive the results.

In an alternative embodiment, the user contacts the call center and enters identification information under guidance of the call center. Call center guidance may be provided through predetermined questions asked by a voice interface 68 or by textual questions that appear on the user's screen 34, such as “please enter a first name or initial”, “please enter a family name”, “please enter a street address”.

The embodiment may be associated with a speech to text converter (not shown) so that a user may speak the desired address information into the converter. The converter preferably converts the speech into text. Should the conversion to text be erroneous, the ASE may compensate for the error and a search for the desired directory entry may be carried out as described above.

In the present example, the user is searching for J. Mack of Holon. He keys in, as the search string, 5 as a first initial and 6225 as a family name, using reduced keyboard 10, and the approximate search engine resolves the input under zero distance to two of the entries in the directory as shown, one in which J is the only initial and one in which J is the spouse's initial.

In the event of two results, a preferred embodiment simply presents the results to the user and allows him to choose. In the event of a large number of results, the user may be asked further questions until the number of results is reduced to a manageable amount.

If no result is shown under zero distance, then the approximate search engine can be set to look for results at distance 1.

In the event of failure to reach either any results or a manageably small number of results after a predetermined number of questions, a preferred embodiment refers a user to a human operator.

It is appreciated that although the present embodiment has been illustrated in association with a mobile telephone having a reduced keyboard, such a call center is not restricted to access by such devices and may work with any telecommunications device, including those having full keyboards such as computers having telephone functionality.

The present invention is also applicable to interactive television. In interactive television the user makes use of a unit that is substantially the currently known television remote control unit to interact with the television or with any kind of service such as Internet or remote shopping provided to the television screen. The present embodiments may be used to improve the utility of the remote control unit so that it serves effectively as a full keyboard.

A further embodiment of the present invention involves a device for locating products. Particularly but not exclusively applicable to applications involving remote shopping, approximate matching techniques of the kind described above, preferably involving approximate keyboards, may be used for product matching, in which an input string is matched against a list of available products. Such product matching enables a user to search for a product using keywords, perhaps against catalog entries giving specifications and descriptions of products.

Embodiments of the present invention thus provide a way of interfacing users to data networks in a way that builds in tolerance to inaccurately entered data and particularly allows data networks to be accessed via methods of entering data that are in practice inaccurate.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description.

1. An ambiguity resolver having
an input for receiving a data string entered using an ambiguous data source,
a comparator for comparing the data string to be searched against a plurality of strings to find at least one closest match to the data string,
and an output for outputting a comparison result.

2. An ambiguity resolver according to claim 1, wherein the comparator comprises a distance assessor for assessing a distance of any of the plurality of prestored words to the data string based on a mapping of characters of the word and of the data string to keys of the ambiguous keyboard.

3. An ambiguity resolver according to claim 2, wherein the distance assessor is operable to assign a minimal distance between pairs of characters sharing a single key of the ambiguous keyboard.

4. An ambiguity resolver according to claim 1, wherein the ambiguous data source is any one of a group comprising a graphical data input, an ambiguous keyboard and a speech converter.

5. An ambiguity resolver according to claim 2, wherein the distance assessor comprises a pattern matcher operable to assess the distance based on pattern matching.

6. An ambiguity resolver according to claim 1, wherein the output is data associated with the at least one closest match.

7. An ambiguity resolver according to claim 1, wherein the output is the at least one closest match.

8. An ambiguity resolver according to claim 1, wherein the plurality of words are stored in at least one database.

9. An ambiguity resolver according to claim 1, wherein at least some of the prestored words are user-specific words.

10. An ambiguity resolver according to claim 1, wherein the input data string is a plurality of words and the output is a phrase.

11. An ambiguity resolver according to claim 4, wherein the speech convertor is a speech processor capable of converting speech into either one of a string of phonemes and text string.

12. An ambiguity resolver according to claim 1, wherein the output is connectable to the input of a further approximate search engine.

13. An ambiguity resolver according to claim 1, wherein the database comprises electronic network address information of a plurality of network users.

14. An ambiguity resolver according to claim 13, wherein the electronic network address information is any one of a group comprising
Intranet email addresses, Internet email addresses, IM addressing data, and URL data.

15. The use of an approximate search engine on data strings entered using an ambiguous keyboard, to resolve key ambiguities of the ambiguous keyboard.

16. The use according to claim 15, wherein the approximate search engine comprises a distance assessor operable to assess a distance of any of a plurality of prestored words to the data string based on a mapping of characters of the word and of the data string to keys of the ambiguous keyboard.

17. The use according to claim 16, wherein the distance assessor comprises a pattern matcher for assessing the distance using pattern matching between the input data string and any one of the prestored words.

18. The use according to claim 16, wherein the plurality of words are stored in at least one database.

19. The use according to claim 16, wherein at least some of the prestored words are user-specific words.

20. The use according to claim 16, wherein the input data string is a plurality of words and wherein the approximate search engine is further operable to match phrases to the plurality of words which have been resolved.

21. The use according to claim 18, wherein the database comprises electronic network address information of a plurality of network users.

22. The use according to claim 21, wherein the electronic network address information is any one of a group comprising
Intranet email addresses, Internet email addresses, IM addressing data, telephone numbers, telephone numbers combined with other address information, and URL data.

23. An approximate search engine having
an input for receiving a data string from a mobile telecommunication device,
an approximate string comparator for comparing the input data string against a plurality of prestored words to find at least one prestored word being closest to the input data string, and
an output for outputting the at least one closest prestored word.

24. An approximate search engine according to claim 23, wherein the comparator is operable to assess a distance of any of the plurality of prestored words to the data string based on a mapping of characters of the word and of the data string to keys of the ambiguous keyboard.

25. An approximate search engine according to claim 23, wherein the comparator is operable to assess the distance based on pattern matching.

26. An approximate search engine according to claim 23, wherein the output is usable to obtain data associated with the closest prestored word.

27. An approximate search engine according to claim 23, wherein the plurality of words are stored in at least one database.

28. An approximate search engine according to claim 23, wherein at least some of the prestored words are user-specific words.

29. An approximate search engine according to claim 23, wherein the input data string comprises a plurality of words and the plurality of prestored words are associated with phrases.

30. An approximate search engine according to claim 23, wherein the input data string comprises a plurality of words and the plurality of prestored words are phrases.

31. An approximate search engine according to claim 23, wherein the input is connected to the output of a speech processor operable to convert speech input into text.

32. An approximate search engine according to claim 23, wherein the database comprises electronic network address information of a plurality of network users.

33. An approximate search engine according to claim 23 wherein the electronic network address information is any one of a group comprising
Intranet email addresses, Internet email addresses, telephone numbers, telephone numbers associated with other identifying data, IM addressing data, and URL data.

34. An approximate search engine according to claim 23, wherein the plurality of prestored words is a user directory containing identification and address information of network users and which approximate search engine comprises a voice interface for interfacing with the mobile telephony device.

35. An approximate search engine according to claim 23, operable to receive query data from the mobile telephony device, disconnect from the mobile telephony device, process the query and reconnect to the mobile telephony device to send a result.

36. An approximate search engine having
an input for receiving a data string to be searched,
a comparator for comparing the data string to be searched against a plurality of prestored words to find at least one closest match to the data string,
and an output for outputting a comparison result,
wherein the comparator comprises a pattern matcher for obtaining the at least one closest match by pattern matching.

37. An approximate search engine according to claim 36, wherein the output is data associated with the at least one closest match.

38. An approximate search engine according to claim 36, wherein the output is the at least one closest match.

39. An approximate search engine according to claim 36, wherein the plurality of prestored words are stored in at least one database.

40. An approximate search engine according to claim 36, wherein at least some of the prestored words are user-specific words.

41. An approximate search engine according to claim 36, wherein the input data string comprises a plurality of words and the plurality of prestored words are associated with phrases.

42. An approximate search engine according to claim 36, wherein the input data string comprises a plurality of words and the plurality of prestored words are phrases.

43. An approximate search engine according to claim 36, wherein the input is connected to the output of a speech processor operable to convert speech input into text.

44. An approximate search engine according to claim 36, wherein the database comprises electronic network address information of a plurality of network users.

45. An approximate search engine according to claim 36 wherein the electronic network address information is any one of a group comprising
Intranet email addresses, Internet email addresses, telephone numbers, telephone numbers associated with other identification information, IM addressing data, and URL data.

46. An approximate search engine according to claim 36, further comprising a voice interface for interfacing with a telephony device.

47. An approximate search engine according to claim 36, operable to receive query data from the telephony device, disconnect from the telephony device, process the query and reconnect to the telephony device to deliver a result.

48. A mobile data processing device having
an ambiguous keyboard for entering a number of input characters via a smaller number of input keys, wherein at least one key has a plurality of the input characters mapped thereto,
an approximate searching, engine, and
a database of expected strings,
wherein distances are predefined between input characters based on respective keys to which they are mapped, and wherein the approximate searching engine is operable to match a given input string against the expected strings to produce at least one candidate string having a minimal distance to the input string.

49. A method of entering precise data into a system via an ambiguous keyboard, comprising the steps of:
entering the data ambiguously via the ambiguous keyboard,
comparing the data against a database of likely inputs using an approximate search engine until at least one closest match is determined, and selecting the at least one closest match as precise input.

50. A method according to claim 49, wherein the approximate searching method is any one of a group comprising neural network algorithms, pattern matching, and a combination thereof.

51. A method according to claim 49, wherein the data is a word.

52. A method according to claim 49, wherein the data is a phrase.

53. A method according to claim 52, wherein the phrase is part of the lyrics of a song.

54. A method according to claim 49, wherein data input is carried out at a mobile data processing device and approximate searching is carried out remotely.

55. A method according to claim 49, wherein data input and approximate searching are carried out at a mobile data processing device.

56. A method according to claim 49, wherein the database is any one of a group comprising a dictionary of a predetermined language, a database of address information, a phrase dictionary, an index of documents, an index of websites, an index of song lyrics, an index of identification information and a graphical index of identification information.

57. An interactive television system comprising
an ambiguity resolver having
an input for receiving a data string entered using an ambiguous data source,
a comparator for comparing the data string to be searched against a plurality of strings to find at least one closest match to the data string,
and an output for outputting a comparison result.

58. An interactive television system comprising an ambiguity resolver according to claim 57, wherein the comparator comprises a distance assessor for assessing a distance of any of the plurality of prestored words to the data string based on a mapping of characters of the word and of the data string to keys of the ambiguous keyboard.

59. An interactive television system comprising an ambiguity resolver according to claim 58, wherein the distance assessor is operable to assign a minimal distance between pairs of characters sharing a single key of the ambiguous keyboard.

60. An interactive television system comprising an ambiguity resolver according to claim 57, wherein the ambiguous data source is any one of a group comprising a graphical data input, an ambiguous keyboard and a speech converter.

61. An interactive television system comprising an ambiguity resolver according to claim 58, wherein the distance assessor comprises a pattern matcher operable to assess the distance based on pattern matching.

62. An interactive television system comprising an ambiguity resolver according to claim 57, wherein the output is data associated with the at least one closest match.

63. An interactive television system comprising an ambiguity resolver according to claim 57, wherein the output is the at least one closest match.

64. An interactive television system comprising an ambiguity resolver according to claim 57, wherein the plurality of words are stored in at least one database.

65. An interactive television system comprising an ambiguity resolver according to claim 57, wherein at least some of the prestored words are user-specific words.

66. An interactive television system comprising an ambiguity resolver according to claim 57, wherein the input data string is a plurality of words and the output is a phrase.

67. A reduced keyboard having a first number of input keys representing a second number of input characters wherein the second number is greater than the first number such that a plurality of characters are mapped to at least some input keys, wherein the characters are divided into groups and wherein the reduced keyboard has a mode switch for switching the input keys between each group of characters.

68. A reduced keyboard according to claim 67, wherein one group comprises the numeric characters and another group comprises the alphabetic characters.

69. An automated call center comprising an approximate search engine and a database and wherein incoming strings serve to interrogate the database using the approximate search engine to output subscriber contact data.

70. An automated call center according to claim 69, further comprising a speech to text engine for converting user speech into an incoming string.

71. An automated call center wherein the approximate search engine is operative to compensate for data entered via an ambiguous keyboard.

72. An electronic network address verifier comprising a database of addresses on the electronic network, a message address checker and an approximate search engine, and wherein the checker is operable to identify an address in a message for the network and to use the address to interrogate the database using the approximate search engine.

73. An electronic network address verifier according to claim 72, operable to identify closest matches to the address, and wherein, when the closest match is not an exact match, to identify the closest match as a correction.
